(19) United States
(12) Patent Application Publication
(10) Pub. No.: US 2005/0173830 A1
(43) Pub. Date: Aug. 11, 2005

(54) Moldings based on polyurethane binders

(76) Inventors: Lothar Thiele, Langenfeld (DE); Hans-Peter Kohlstadt, Velbert (DE); Andre te Poel, Willich (DE)

Correspondence Address: HENKEL CORPORATION, THE TRIAD, SUITE 200, 2200 RENAISSANCE BLVD., GULPH MILLS, PA, 19406, US

(21) Appl. No.: 11/002,950

(22) Filed: Dec. 1, 2004

(30) Foreign Application Priority Data
Dec. 5, 2003 (DE) 103 56 767.4

(51) Int. Cl. B29C 31/00

(52) U.S. Cl. 264/240

(57) ABSTRACT

Moldings based on polyurethane binders containing at least one polyisocyanate, at least one polyol or polyamine, at least one carboxylic acid such as a long-chain fatty acid, and, if appropriate, water and/or one or more amines with one or more fillers have high flexibility if the average particle diameter of the fillers is up to 2.5 mm. The fillers preferably contain particles having round, oval or completely irregular structures. The binder composition and the fillers are reacted at a pressure of 1 MPa to 40 MPa (preferably, at temperatures of from about 60 to about 180° C. for from about 1 to 30 min), and then the shaping apparatus is depressurized. The resultant moldings are suitable for the production of sheets or of semifinished products for the coating of furniture, kitchen worktops, floors, walls, stairs, or ceilings.

### CROSS-REFERENCE TO RELATED APPLICATIONS

This application claims priority under 35 U.S.C. Section 119 to German Application DE 10356767.4, filed 5 Dec. 2003, incorporated herein by reference in its entirety.

### FIELD OF THE INVENTION

The present invention relates to a process for the production of flexible moldings based on polyurethane binders, and also to the use of these moldings.

### DISCUSSION OF THE RELATED ART

The production of sheets and moldings from compact or foaming binders or fillers is known. For example, ground marble or ground granite and synthetic resins, for example based on unsaturated polyesters, can be used to produce synthetic marble materials or synthetic granite materials. For this, the synthetic resin material is generally mixed with the ground marble or ground granite and homogenized in large molds and cured in the form of a block which is then trimmed to give the appropriate moldings, such as sheets and other semifinished products.

WO 02/094523 describes a production process for the production of panels, of tiles, and of similar sheet-like moldings composed of agglomerates of minerals, e.g. terracotta, granulated material or ground marble or ground granite, or else ground brick, via mixing of these mineral fillers with a two-component or hot-curing resin. This mixture is then intended to be cast onto a flat substrate with side walls to a defined layer thickness. This layer is then intended to be introduced between heated plates of a press so that the polymerization of the resin is carried out with exposure to heat and pressure. The intention is to produce a hardened flame-resistant, water-resistant sheet which resists mechanical stresses and which is suitable for a wide variety of applications. Applications mentioned are floorcoverings, stairs, wallcoverings, furniture, kitchens, worktops, tables, benches, and the like. That specification says nothing about the binders to be used.

WO 99/30882 describes moldings composed in essence of wood particles and/or of cellulose-containing material and of a porous polyurethane binder, where the ratio by weight of the binder to the wood particles or cellulose-containing material is from 0.05 to 1.0:1.0. The specification proposes producing these moldings via the reaction of at least one polyisocyanate with at least one polyol or polyamine and with at least one carboxylic acid as blowing agent. The reaction is preferably intended to be carried out at temperatures of from 80 to 100° C. and with an initial pressure of more than 1 kp/cm². The formation of gas, and with this the final properties of the foamed moldings, are intended to be substantially independent of the moisture content of the wood particles and/or of the cellulose-containing material. This is particularly intended to apply for high strength values and plasticity.

U.S. 2003/0090016 A1 describes a binder composed of a soy-oil-based polyol and of an isocyanate, which is mixed with aggregates. The intention here is to achieve different mechanical properties by way of the aggregate composition. Aggregate materials mentioned are minerals, ceramic, glass, fly ash, limestone, sand, shingle, ground rock, metal fibers, and mixtures of these fillers.

WO 98/58994 describes a process for the production of sheets or of moldings, and also describes sheet-like semifinished products and interior-decoration items. For these, a natural and/or synthetic rock flour with a sieve particle size of from 1.0 to 250 μm is to be admixed with a polyurethane foam. The components are to be introduced within a heatable mold for foaming, the temperature being kept at from 20° C. to 80° C., and the mixture being kept in a mold under a pressure of from 2 MPa to 13 MPa for foaming until the density reached is from 80 kg/m³ to 2000 kg/m³. Filler materials proposed comprise powdered quartz, slurries from stone-grinding, finely ground silicate glass, and the like. That specification also proposes that in what is known as an in-mold process, the mixture foamed in the heated mold be directly bonded to a natural stone plate, a metal plate, or a timber material. That specification gives no further information concerning the binder system.

### BRIEF SUMMARY OF THE INVENTION

In the light of this prior art, the inventors had the object of providing a process which can produce flexible moldings based on polyurethane binders and which can use a wide variety of fine-particle and inexpensive fillers, and where the resultant molding has sufficient elasticity to withstand high flexural loads.

The inventive process comprises preparing a binder composition comprising one or more polyisocyanates, one or more reactants selected from the group consisting of polyols and polyamines, and one or more carboxylic acids and, if appropriate, water and/or one or more amines with one or more fillers with an average particle diameter of up to 2.5 mm, and then reacting this mixture, using a pressure of from about 1 MPa to about 40 MPa and preferably temperatures of from about 60° C. to about 180° C. for preferably from about 1 to about 30 min, and then depressurizing. Use is preferably made of a pressure of from about 5 MPa to about 30 MPa and a temperature range of from about 80° C. to about 120° C.

### DETAILED DESCRIPTION OF CERTAIN EMBODIMENTS OF THE INVENTION

This reaction may be carried out in closed molds, in molds with movable rams, in platen presses with or without molds, or in belt presses or twin-belt presses. In the case of the latter, the method of depressurization is that the molding formed continuously leaves the region of pressure. If the process is carried out in closed molds, in molds with movable ram, or in platen presses, it is advantageous for the product of the reaction to be cooled after the depressurization step and not to be removed until the shaping apparatus has been cooled. In these cases it can be necessary to delay removal of the fully reacted molding from the shaping apparatus until temperatures are below about 40° C.-80° C.

Examples of suitable fillers are ground rubber, ground foam, wood flour, comminuted nutshells, in particular coconut shells, metal powder, comminuted plastics waste, comminuted mussel shells, sand, gravel, rock flour, ground marble, ground glass, ground ceramic, ground brick and mixtures of these materials, and this selection depends on the color and structure which the resultant moldings or sheet materials are to have. Other fillers which may also be used if appropriate, either alone or in combination with the abovementioned fillers, are expanded clay, expanded glass, expanded ceramic, hollow glass beads or ceramic beads, or a mixture of these materials.

In order to achieve flexibility of the moldings thus produced, the geometry of the particles is important. The geometry of the filler particles should comprise round, oval or completely irregular structures, and in particular preferably should not comprise any parallel surfaces or flat surfaces. This means that particles having the shape of parallelepipeds, cubes, pyramids, octahedra or tetrahedra are generally unsuitable for the production of the inventive moldings; the filler used thus preferably is essentially free of particles having such shapes. The filler particles preferably have a low length/width or thickness ratio (“aspect ratio”) of from about 0.5 to about 2. The filler here may comprise very high fines content of up to 50% by weight with an average particle diameter smaller than 0.25 μm, and in particular it is also possible to make concomitant use of very high dust content in the filler. For the purposes of this invention dusts here are filler particles whose average particle diameter is smaller than 0.1 μm, and up to 20% by weight of these may be present in the filler mixture.

It has now been found to be important for the inventive process that, during the reaction, the binder mixture comprises one or more blowing agents, and the blowing agents here bring about a microporous structure. The use of foaming binders is firstly important to reduce weight in comparison with compact binder systems. Secondly, the foaming pressure can be utilized in order to bring about the penetration, through the binder components, of the filler constituents to be bound. A chemical reaction may take place here between the particles of the fillers and the binder. This gives a very strong bond between the binder and the particles. It has been found possible to produce elastified moldings even when hard fillers are bound to rigid foaming polyurethane binders, a precondition being that the filler particles have the abovementioned particle geometry and sufficiently high pressure is used during the production of the moldings. The pressures required are from about 1 MPa to about 40 MPa, preferably from about 5 MPa to about 30 MPa. The reaction temperatures during the curing of the binder system under pressure are preferably from about 60° C. to about 180° C., with suitable more preferred temperatures being from about 80° C. to about 160° C. The residence time depends on the apparatus in which the reaction is carried out under pressure, but generally is from about 1 to about 30 min.

The ratio of binder (entirety of polyisocyanate, polyol and/or polyamine, carboxylic acid and, if appropriate, other binder constituents) to fillers is to be from about 0.5:9.5 to about 5:5, preferably from about 0.75:9.25 to about 2:8.

The polyurethane binders used for the purposes of the inventive process comprise at least one polyol and/or polyamine, at least one polyisocyanate, and at least one carboxylic acid. The carboxylic acid and, if appropriate, water, may function as blowing agents for pore formation in the foam obtained by reaction of the binder components. Hydroxycarboxylic acids or aminocarboxylic acids may also be used instead of polyols and carboxylic acids, and polyols may be replaced entirely or to some extent by polyamines.

The polyisocyanates are polyfunctional, and the suitable polyfunctional isocyanates preferably contain an average of from 2 to at most 5, preferably up to 4, and in particular 2 or 3, isocyanate groups per molecule. The polyisocyanates to be used may be aromatic, cycloaliphatic or aliphatic isocyanates.

Examples of suitable aromatic polyisocyanates are: all of the isomers of tolylene diisocyanate (TDI) either in isomerically pure form or in the form of a mixture of two or more isomers, naphthalene 1,5-diisocyanate, diphenylmethane 4,4′-diisocyanate (MDI), diphenyl-methane 2,4′-diisocyanate, and mixtures of diphenyl-methane 4,4′-diisocyanate with the 2,4′-isomer, or their mixtures with higher-functionality oligomers (known as crude MDI), xylylene diisocyanate (XDI), diphenyldimethylmethane 4,4′-diisocyanate, di- and tetraalkyldiphenylmethane diisocyanate, dibenzyl 4,4′-diisocyanate, phenylene 1,3-diisocyanate, phenylene 1,4-diisocyanate. Examples of suitable cycloaliphatic polyisocyanates are the hydrogenation products of the abovementioned aromatic diisocyanates, e.g. dicyclohexylmethane 4,4′-diisocyanate (H₁₂MDI), 1-isocyanatomethyl-3-isocyanato-1,5,5-trimethylcyclo-hexane (isophorone diisocyanate, IPDI), cyclohexane 1,4-diisocyanate, hydrogenated xylylene diisocyanate (H₆XDI), 1-methyl-2,4-diisocyanatocyclohexane, m- or p-tetramethylxylene diisocyanate (m-TMXDI, p-TMXDI), and dimer fatty acid diisocyanate. Examples of aliphatic polyisocyanates are tetramethoxybutane 1,4-diisocyanate, butane 1,4-diisocyanate, hexane 1,6-diisocyanate (HDI), 1,6-diisocyanato-2,2,4-tri-methylhexane, 1,6-diisocyanato-2,4,4-trimethylhexane, butane 1,4-diisocyanate, and dodecane 1,12-diisocyanate (C₁₂DI).

Preference is generally given to aromatic isocyanates, and diphenylmethane diisocyanate is preferred, either in the form of the pure isomers, in the form of isomer mixtures of the 2,4′-/4,4′-isomers, or else MDI whose viscosity has been reduced with carbodiimide, for example the product known by way of example with the trade name ISONATE 143 L, and also the product known as “crude MDI”, i.e., an isomer/oligomer mixture related to MDI, e.g. that obtainable commercially with the trade name PAPI or DESMODUR VK. Use may also be made of what are known as “quasi-prepolymers”, i.e. products of the reaction of MDI or, respectively, TDI with low-molecular-weight diols, e.g., ethylene glycol, diethylene glycol, propylene glycol, dipropylene glycol, or triethylene glycol. These quasi prepolymers are known to be a mixture of the abovementioned reaction products with monomeric diisocyanates. Very surprisingly, even aliphatic and cycloaliphatic isocyanates can react rapidly and completely to give the inventive foams, even at low temperatures. Use may be made not only of the abovementioned aliphatic and cycloaliphatic isocyanates but also of their isocyanuratization products or biuretization products, in particular those of HDI or of IPDI.

In principle, all of the polyols known hitherto for polyurethane production are also suitable for the present invention. In particular, those which may be used are the polyhydroxy polyethers known per se in the number average molecular weight range from about 60 to about 10,000, preferably from about 70 to about 6000, having from 2 to 10 hydroxy groups per molecule. These polyhydroxy polyethers are obtained in a manner known per se via alkoxylation of suitable starter molecules, e.g., of water, propylene glycol, glycerol, trimethylolpropane, sorbitol, sucrose, etc. Particularly suitable alkoxylating agents are propylene oxide and sometimes also ethylene oxide. Included within this class of polyhydroxy polyethers are oligomers of glycols such as diethylene glycol, triethylene glycol, dipropylene glycol, triethylene glycol, and the like.

Materials with preferred suitability are the liquid polyhydroxy compounds having two or three hydroxy groups per molecule, e.g., di- and/or trihydric polypropylene glycols in the molecular weight range (number average molecular weight) from about 200 to about 6000, preferably in the range from about 400 to about 3000. Use may also be made of random and/or block copolymers of ethylene oxide and of propylene oxide. Another group of polyethers whose use is preferred are the polytetramethylene glycols prepared, by way of example, via the acidic polymerization of tetrahydro-furan, the number average molecular weight range of these polytetramethylene glycols being from about 200 to about 6000, preferably in the range from about 400 to about 4000.

Additional suitable polyols are monomeric compounds containing at least two (e.g., 2 to 4) hydroxyl groups per molecule. Polyols of this type include glycols and other difunctional alcohols such as ethylene glycol, propylene glycol, 1,4-butanediol, neopentyl glycol, 2-methyl-1,3-propanediol, and the like. Suitable monomeric polyols having more than two hydroxyl groups per molecule include glycerol, trimethylolpropane, trimethylolethane, pentaerythritol, sugar alcohols, and sugars.

Other suitable polyols are the liquid polyesters which can be prepared via condensation of di- or tricarboxylic acids, e.g., adipic acid, sebacic acid, glutaric acid, azelaic acid, hexahydrophthalic acid, or phthalic acid with low-molecular-weight diols or low-molecular-weight triols, e.g., ethylene glycol, propylene glycol, diethylene glycol, triethylene glycol, dipropylene glycol, 1,4-butanediol, 1,6-hexanediol, 1,10-decanediol, glycerol, or trimethylolpropane.

Another group of polyols to be used according to the invention is that of the polyesters based on ε-caprolactone, also termed “polycaprolactones”.

However, use may also be made of polyester polyols derived from oleochemistry. By way of example, these polyester polyols may be obtained via complete ring-opening of epoxidized triglycerides of an at least to some extent olefinically unsaturated fatty-acid-containing fat mixture with one or more alcohols having from 1 to 12 carbon atoms and subsequent partial transesterification of the triglyceride derivatives to give alkyl ester polyols having from 1 to 12 carbon atoms in the alkyl radical. Other suitable polyols are polycarbonate polyols and dimer diols (Henkel), and also castor oil and its derivatives. Other materials which may be used as polyols for the inventive compositions are the hydroxy-functional polybutadienes, such as those obtainable with the trade name “Poly-bd”.

In particular, the polyol component is a diol/triol mixture composed of polyether polyols and of polyester polyols.

Suitable polyamines include any of the oligomeric and polymeric substances known in the polyurethane art that contain two or more primary or secondary amino groups per molecule that are capable of reacting with isocyanate functional groups. For example, amine-terminated polyethers obtained by conversion of the hydroxyl groups of polyhydroxy polyethers to amino groups, such as the amine-terminated polyethers sold under the “Jeffamine” trade name by Huntsman Chemical, are suitable for use in the present invention.

The carboxylic acids to be used according to the invention react with the isocyanates in the presence of catalysts with elimination of carbon dioxide to give amides, and they therefore have the twin function of 30 involvement in the structure of the polymer skeleton and simultaneously acting as blowing agent via the elimination of the carbon dioxide.

“Carboxylic acids” are acids which have one or more—35 preferably up to three—carboxy groups (—COOH) and at least 2, preferably from 5 to 400, carbon atoms. The carboxy groups may have bonding to saturated or unsaturated, linear or branched radicals of alkyl or cycloalkyl type, or to aromatic radicals. They may contain other groups, such as ether groups, ester groups, halogen groups, amide groups, amino groups, hydroxy groups, and urea groups. However, preference is given to carboxylic acids which take the form of liquids at room temperature and are easy to incorporate, e.g., native fatty acids or fatty acid mixtures, COOH-terminated polyesters, polyethers or polyamides, dimer fatty acids and trimer fatty acids. Specific examples of the carboxylic acids are: acetic acid, valeric acid, caproic acid, caprylic acid, capric acid, lauric acid, myristic acid, palmitic acid, stearic acid, isostearic acid, isopalmitic acid, arachic acid, behenic acid, cerotinic acid and melissic acid, and also the following mono- or polyunsaturated acids: palmitoleic acid, oleic acid, elaidic acid, petroselic acid, erucic acid, linoleic acid, linolenic acid, and gadoleic acid. Mention may also be made of: adipic acid, sebacic acid, isophthalic acid, terephthalic acid, trimellitic acid, phthalic acid, hexahydrophthalic acid, tetrachlorophthalic acid, oxalic acid, muconic acid, succinic acid, fumaric acid, ricinoleic acid, 12-hydroxystearic acid, citric acid, tartaric acid, di- or trimerized unsaturated fatty acids, if appropriate in a mixture with monomeric unsaturated fatty acids, and, if appropriate, partial esters of these compounds. It is also possible to use esters of polycarboxylic acids or of carboxylic acid mixtures, where these have not only COOH groups but also OH groups, for example esters of TMP [C₂H₅—C(CH₂OH)₃], glycerol, pentaerythritol, sorbitol, glycol, or their alkoxylates with adipic acid, sebacic acid, citric acid, tartaric acid, or graft or partially esterified carbohydrates (sugar, starch, cellulose) and ring-opening products of epoxides with polycarboxylic acids.

Among the “carboxylic acids” are not only the amino-carboxylic acids but also preferably “hydroxycarboxylic acids”. “Hydroxycarboxylic acids” are monohydroxymono-carboxylic acids, monohydroxypolycarboxylic acids, polyhydroxymonocarboxylic acids, and polyhydroxypoly-carboxylic acids, including the corresponding hydroxy-alkoxycarboxylic acids having from 2 to 600, preferably having from 8 to 400, and in particular having from 14 to 120, carbon atoms, where these contain from 1 to 9, preferably from 2 to 3, hydroxy groups or carboxy groups on an H—C radical, in particular on an aliphatic radical. The polyhydroxymonocarboxylic acids and the polyhydroxypolycarboxylic acids including the corresponding hydroxyalkoxycarboxylic acids are classified as polyhydroxy fatty acids. The dihydroxy fatty acids preferably used, and also their preparation, are described in DE-A-33 18 596 and EP 237 959, which are expressly incorporated herein by way of reference.

The polyhydroxy fatty acids used according to the invention are preferably derived from naturally occurring fatty acids. They therefore generally have an even number of carbon atoms in the main chain and are not branched. Those having a chain length of from 8 to 100, in particular from 14 to 22, carbon atoms are particularly suitable. For industrial uses, natural fatty acids are mostly used in the form of industrial mixtures. These mixtures preferably comprise a portion of oleic acid. They may moreover comprise other saturated, monounsaturated, and polyunsaturated fatty acids. During the preparation of the polyhydroxy or polyhydroxyalkoxy fatty acids which may be used according to the invention use may in principle be made of mixtures of different chain lengths which may also comprise saturated fractions, or else may comprise polyhydroxyalkoxycarboxylic acids having double bonds. Suitable materials here are therefore not only the pure polyhydroxy fatty acids but also mixed products obtained from animal fats or from vegetable oils, where these after work-up (ester cleavage, purification stages) have >40%, preferably >60%, content of monounsaturated fatty acids. Examples of these are commercially available natural raw materials, e.g. bovine tallow in which the chain distribution is 67% of oleic acid, 2% of stearic acid, 1% of heptadecanoic acid, 10% of saturated acids of chain length C₁₂-C₁₆, 12% of linoleic acid and 2% of saturated acids >C₁₈ carbon atoms or, by way of example, the oil from the new sunflower (nsf), the composition of which is about 80% of oleic acid, 5% of stearic acid, 8% of linoleic acid, and about 7% of palmitic acid. After ring-opening, these products can be briefly distilled in order to reduce the content of unsaturated fatty acid esters. Further purification steps (e.g., longer-duration distillation) are also possible.

The polyhydroxy fatty acids used according to the invention preferably derive from monounsaturated fatty acids, e.g., from 4,5-tetradecenoic acid, 9,10-tetradecenoic acid, 9,10-pentadecenoic acid, 9,10-hexadecenoic acid, 9,10-heptadecenoic acid, 6,7-octadecenoic acid, 9,10-octadecenoic acid, 11,12-octadecenoic acid, 11,12-eicosenoic acid, 11,12-docosenoic acid, 13,14-docosenoic acid, 15,16-tetracosenoic acid, or 9,10-ximenic acid. Preference among these is given to oleic acid (9,10-octadecenoic acid). cis- and trans-isomers of all of the fatty acids mentioned are suitable.

Other suitable materials are polyhydroxy fatty acids which derive from less frequently encountered unsaturated fatty acids, such as decyl-12-enoic acid, stillingic acid, dodecyl-9-enoic acid, ricinoleic acid, petroselic acid, vaccenic acid, eleostearic acid, punicic acid, licanic acid, parinaric acid, gadoleic acid, arachidonic acid, 5-eicosenoic acid, 5-docosenoic acid, cetoleic acid, 5,13-docosadienoic acid, and/or selacholeic acid.

Other suitable materials are polyhydroxy fatty acids which have been prepared from isomerization products of natural unsaturated fatty acids. The resultant polyhydroxy fatty acids differ only in the position of the hydroxy or the hydroxyalkoxy groups in the molecule. They are generally mixtures. Although naturally occurring fatty acids, these being raw materials of natural origin, are preferred as starting component for the purposes of the present invention, this does not exclude the suitability of synthetically prepared carboxylic acids having appropriate numbers of carbon atoms.

A hydroxyalkoxy radical on the polyhydroxy fatty acids derives from the polyol which has been used for the ring-opening of the epoxidized fatty acid derivative. Preference is given to polyhydroxy fatty acids whose hydroxyalkoxy group derives from preferably primary dihydric alcohols having up to 24 carbon atoms, in particular up to 12 carbon atoms. Suitable diols include propanediol, butanediol, pentanediol, and hexanediol, dodecanediol, preferably 1,2-ethanediol, 1,4-butanediol, 1,6-hexanediol, polypropylene glycol, polybutanediol, and/or polyethylene glycol with a degree of polymerization of from 2 to 40. Other particularly suitable diol compounds are polypropylene glycol and/or polytetrahydrofurandiol, and also their copolymerization products. This applies particularly if each of these compounds has a degree of polymerization of from about 2 to 20 units. However, triols or alcohols of even higher functionality can also be used for the ring-opening process, e.g., glycerol and trimethylolpropane, and also their adducts of ethylene oxide and/or propylene oxide with molecular weights up to about 1500. This then gives polyhydroxy fatty acids with more than 2 hydroxy groups per molecule.

For the ring-opening process, a hydroxycarboxylic acid may also be used instead of a polyol as hydroxy-containing compound, e.g., citric acid, ricinoleic acid, 12-hydroxystearic acid, lactic acid. This then gives ester groups instead of ether groups. The ring-opening process may also use amines, or may use amine carboxylic acids or, respectively, amines bearing hydroxy groups.

However, preference is given to dihydroxy fatty acids, in particular derived from diols. They are liquid at room temperature and can easily be mixed with the other reactants. For the purposes of the invention, dihydroxy fatty acids are not only the ring-opening products of epoxidized unsaturated fatty acids with water but also the corresponding ring-opening products with diols and their crosslinking products with further epoxide molecules. The somewhat more precise term dihydroxyalkoxy fatty acids can also be used for the ring-opening products with diols. There is preferably at least 1, and there are preferably at least 3, in particular at least 6, CH₂ units separating the hydroxy groups or the hydroxyalkoxy group here from the carboxy group.

Preferred dihydroxy fatty acids are: 9,10-dihydroxypalmitic acid, 9,10-dihydroxystearic acid, and 13,14-dihydroxybehenic acid, and also the 10,9- and, respectively, 14,13-isomers thereof.

Polyunsaturated fatty acids are also suitable, e.g., linoleic acid and linolenic acid. Cinnamic acid may be mentioned as a specific example of an aromatic carboxylic acid. The blowing reaction, i.e. the CO₂ formation for the foaming process, may take place either via the reaction of isocyanate groups of the polyisocyanate with water or else via the reaction of the isocyanate groups with the carboxylic acid groups of the carboxylic acids.

If the CO₂ elimination from the isocyanate-carboxylic acid reaction is intended to start even at a low temperature it is advantageous to use amino-substituted pyridines and/or N-substituted imidazoles as catalysts. Particularly suitable compounds are 1-methylimidazole, 2-methyl-1-vinylimidazole, 1-allylimidazole, 1-phenyl-imidazole, 1,2,4,5-tetramethylimidazole, 1-(3-amino-propyl)imidazole, pyrimidazole, 4-dimethylamino-pyridine, 4-pyrrolidinopyridine, 4-morpholinopyridine, 4-methylpyridine and N-dodecyl-2-methylimidazole.

The abovementioned starting materials for the binder, namely polyisocyanate, polyol, polyamine, water, carboxylic acid, and catalyst may be used in the following quantitative proportions: for each equivalent of isocyanate use is made of from about 0.1 to about 1 equivalent, preferably from about 0.8 to about 1 equivalent, of a mixture composed of polyol, polyamine, water, and/or carboxylic acid, and the ratio here of polyol and/or polyamine to water and/or carboxylic acid may be from about 20:1 to about 1:20. The amount of catalyst to be used is from about 0.0001 to about 1.0 equivalent, preferably from about 0.01 to about 0.5 equivalent, of pyridine catalyst or of imidazole catalyst. If, in contrast, water alone is used for the blowing reaction, the addition of the abovementioned pyridines and imidazoles may be omitted. However, if carboxylic acid is the sole blowing agent, these pyridines and/or imidazoles must be used in combination with the basic or organometallic catalysts listed below in order to accelerate the reaction. If use is made of polycarboxylic acids or of hydroxy- or aminocarboxylic acids, the addition of a polyol or polyamine may be omitted entirely. If no polyol, polyamine, or water is involved in the reaction, i.e., if the isocyanates are reacted with the carboxylic acids, the general practice is: for each equivalent of isocyanate use is made of from about 0.1 to about 1 equivalent, preferably from about 0.8 to about 1 equivalent, of carboxylic acid and of from about 0.0001 to about 1.0 equivalent, preferably from about 0.001 to about 0.5 equivalent, of pyridine catalyst or of imidazole catalyst.

If the polyfunctional isocyanates are predominantly reacted with hydroxycarboxylic acids, the concentration preferably to be used of the abovementioned amine catalysts is from about 0.05 to about 15% by weight, in particular from about 0.5 to about 10% by weight, based on the entirety of hydroxycarboxylic acid and isocyanate.

Besides the abovementioned pyridine derivatives and abovementioned imidazole derivatives, other catalysts may also be added. In particular for the isocyanate/polyol and isocyanate/water reaction, use may be made of organometallic compounds, such as stannous salts of carboxylic acids, strong bases, such as alkali metal hydroxides, alkali metal alcoholates, and alkali metal phenolates, e.g., stannous acetate, stannous ethylhexoate, and stannous diethylhexoate. The dialkyltin (IV) carboxylates are a preferred class of compounds. The carboxylic acids have at least 2, preferably at least 10, in particular from 14 to 32, carbon atoms. Use may also be made of dicarboxylic acids. Acids which may expressly be mentioned are: adipic acid, maleic acid, fumaric acid, malonic acid, succinic acid, pimelic acid, terephthalic acid, phenylacetic acid, benzoic acid, acetic acid, propionic acid, and also in particular 2-ethylhexanoic, caprylic, capric, lauric, myristic, palmitic, and stearic acid. Specific compounds are dibutyl- and dioctyltin diacetate, dibutyl- and dioctyltin maleate, dibutyl- and dioctyltin bis(2-ethylhexoate), dibutyl- and dioctyltin dilaurate, tributyltin acetate, bis(β-methoxycarbonylethyl)tin dilaurate and bis(β-acetylethyl)tin dilaurate.

Preferred use may also be made of tin oxides, tin sulfides, and also tin thiolates. Specific compounds are: bis(tributyltin)oxide, bis(trioctyltin)oxide, dibutyl- and dioctyltin bis(2-ethylhexylthiolate), dibutyl- and dioctyltin didodecylthiolate, bis(β-methoxycarbonylethyl)tin didodecylthiolate, bis(β-acetylethyl)tin bis(2-ethylhexylthiolate), dibutyl- and dioctyltin didodecylthiolate, butyl- and octyltin tris(2-ethylhexylcarbonylthioglycolate), dibutyl- and dioctyl tin bis(2-ethylhexylcarbonylthioglycolate), tributyl and trioctyltin 2-ethylhexylcarbonylthio-glycolate and also butyl- and octyltin tris(thioethylene glycol 2-ethylhexoate), dibutyl- and dioctyltin bis(thioethylene glycol 2-ethylhexoate), tributyl- and trioctyltin (thioethylene glycol 2-ethyl-hexoate) having the general formula Rₙ₊₁Sn (SCH₂CH₂OCOC₈H₁₇)₃₋ₙ, where R is an alkyl group having from 4 to 8 carbon atoms and n is 0, 1 or 2, bis(β-methoxycarbonylethyl)tin bis(thioethylene glycol 2-ethylhexoate), bis(β-methoxycarbonylethyl)tin bis(2-ethylhexylcarbonylthioglycolate), and bis(β-acetylethyl)tin bis(thioethylene glycol 2-ethylhexoate), and bis(β-acetylethyl)tin bis(2-ethylhexylcarbonylthioglycolate).

For the crosslinking of the polyurethane skeleton, the trimerization reaction of the isocyanate groups with themselves or with urethane and urea groups to give allophanate and, respectively, biuret groups may take place. Trimerization catalysts may be used for this purpose. A trimerization catalyst which may be mentioned is DABCO TMR-2 from Air Products, this being quaternary ammonium salts dissolved in ethylene glycol.

Aliphatic tertiary amines are also suitable, in particular if the structure is cyclic. Among suitable tertiary amines are those which also bear groups reactive toward the isocyanates, in particular hydroxy- and/or amino groups. Specific mention may be made of: dimethylmonoethanolamine, diethylmonoethanolamine, methylethylmonoethanolamine, triethanolamine, tri-methanolamine, tripropanolamine, tributanolamine, trihexanolamine, tripentanolamine, tricyclohexanol-amine, diethanolmethylamine, diethanolethylamine, diethanolpropylamine, diethanolbutylamine, diethanol-pentylamine, diethanolhexylamine, diethanolcyclohexyl-amine, diethanolphenylamine and also their ethoxylation and propoxylation products, diazabicyclooctane (sold, for example, under the trade name DABCO), triethylamine, dimethylbenzylamine (sold by Bayer, for example, under the trade name DESMORAPID DB), bis(dimethylaminoethyl) ether (sold by UCC, for example, under the trade name Catalyst A), tetramethylguanidine, bis(dimethylaminomethyl)phenol, 2,2′-dimorpholinodiethyl ether, 2-(2-dimethylaminoethoxy)ethanol, 2-dimethylaminoethyl-3-dimethylaminopropyl ether, bis(2-dimethylaminoethyl) ether, N,N-dimethylpiperazine, N-(2-hydroxyethoxy-ethyl)-2-azanorbornane, TEXACAT DP-914 (sold by Texaco Chemical), N,N,N,N-tetramethylbutane-1,3-diamine, N,N,N,N-tetramethylpropane-1,3-diamine, and N,N,N,N-tetramethylhexane-1,6-diamine.

The catalysts may also be present in oligomerized or polymerized form, e.g., in the form of N-methylated polyethyleneimine.

Because of the carboxylic acid/isocyanate reaction, the polyurethane binders of the moldings produced according to the invention also have, alongside the amide groups, urethane groups from the reaction of the isocyanates with the polyols and/or polyhydroxycarboxylic acids. They also contain urea groups from the reaction of the isocyanates with any water present, or with the polyamines or aminocarboxylic acids of the system. They moreover also contain ester groups and, respectively, ether groups from the polyols used.

The amount of the reactants polyisocyanate, polyol, polyamine, carboxylic acid, and water is selected in such a way as to use an excess of the polyisocyanate.

The equivalence ratio of NCO to the entirety of OH, NH, and COOH groups is less than about 5:1, preferably from about 2:1 to about 1.2:1, very particular preference being given to an isocyanate excess of from about 5 to about 50%.

The moldings produced by the inventive process may be produced here in the form of sheets or semifinished products with a thickness of from about 2 to about 40 mm. If pressures in the inventive range are used, the sheets and moldings have densities which are below the density of the compact material by as little as from 5 to 10%. The molding is found to expand on depressurization. The moldings have a smooth surface. In the case of moldings fractured with cohesive fracture, microscopic investigation shows that the moldings have a three-dimensional microporous foamed structure, and that there are many closed cavities, to some extent honeycomb-shaped. This microscopic structure is similar to what are known as “honeycomb” structures, and it is likely that this microscopic honeycomb structure and the binding of the filler particles into the binder matrix achieve high strengths and high flexibility of the sheets or semifinished products, even at low binder contents.

The moldings produced according to the invention are therefore suitable for the production of sheets or of semifinished products for the coating of furniture, of kitchen worktops, of floors, of walls, of stairs, or of ceilings.

The examples below are intended to provide further illustration of the invention. Unless otherwise stated, all of the quantitative data for these compositions are parts by weight.

### EXAMPLES

A binder composition was prepared according to the following formulation:

| a) Polyol component | |
|---|---|
| Dipropylene glycol | 19.00 |
| Glycerol | 4.90 |
| Polypropylene glycol, Mn 400 | 51.00 |
| Rapeseed fatty acid | 24.16 |
| TEGOSTAB B 8404 | 0.50 |
| Dibutyltin dilaurate | 0.04 |
| N-methylimidazole | 0.40 |
| b) Isocyanate component | |
| Diphenylmethane 4,4′-diisocyanate | 115.0 |

10.5% of binder (polyol component+isocyanate component) was added to ebonite chips of lengths of up to 3 mm composed of sheet ebonite (comparative example 1) and quartz sand with about 30% fine sand content (particle diameter<0.25 mm) and with a particle diameter of up to 2.0 mm (comparative example 2 and inventive example). The mixing with the two components of the polyurethane system here took place in two steps. It was of no concern here which component was used first to treat the ebonite chips or quartz sand. Once the respective mixture had been transferred into a release-agent-impregnated metal mold, the material was compression-molded at a pressure of 150 kp/cm² (15 MPa) and 80° C. The temperature was then kept at this level for 10 minutes. From 5 to 10 minutes after the heating had been switched off, the press was opened and the sheet was removed from the mold (comparative example 1 and inventive example).

In comparative example 2, the same amount of quartz sand-binder mixture of the inventive example was introduced into a likewise release-agent-impregnated mold with sealable cover, and the sheet was likewise produced at 80° C. without additional pressure.

The dimensions of these 3 sheets were 1000×400×4 mm.

The sheets were tested after one week of storage at room temperature. For this, the sheets were placed on triangular-section bars. These bars were lying parallel on a horizontal surface, their separation being 700 mm. The method of superposing the sheets was such that they protruded by a uniform distance 150 mm at each side. A steel plate of dimension 400×80×5 mm was placed in the middle of the stone composite sheet in such a way as to be parallel to the triangular-section bars and to cover the entire width of the composite sheet. A spindle press was used to exert pressure on this metal plate, and the deflection at break was determined.

| | Deflection at |
|---|---|
| Sheet | break in mm |
| Comparative example 1 | 12 |
| Comparative example 2 | 10 |
| Inventive example | 29 |

This flexural test was similar to the 3-point or 4-point flexural test of DIN 53293, but the abovementioned modifications were introduced in order to achieve conclusive results for the moldings produced according to the invention.

The flexural test clearly shows that only the sheets of the inventive example have high elasticity, making them highly resistant to flexural stress.

1. A process for producing a flexible molding, said process comprising:
a) reacting a composition comprising (i) a binder comprising one or more polyisocyanates, one or more reactants selected from the group consisting of polyols and polyamines, and one or more carboxylic acids, wherein said one or more reactants need not be present if at least one carboxylic acid is selected from the group consisting of hydroxycarboxylic acids, polycarboxylic acids and aminocarboxylic acids, and (ii) one or more fillers having an average particle diameter up to 2.5 mm in a shaping apparatus at a pressure of from about 1 MPa to about 40 MPa; and
b) depressurizing the shaping apparatus to obtain the flexible molding.

2. The process claimed in claim 1, wherein, after the depressurizing step b), the flexible molding is cooled and then removed from the shaping apparatus.

3. The process claimed in claim 1, wherein said reacting in step a) is performed at a temperature of from about 60 to about 180° C.

4. The process claimed in claim 1, where said reacting in step a) is performed for about 1 to about 30 minutes.

5. The process claimed in claim 1, wherein the binder to filler weight ratio is from about 0.5:9.5 to about 5:5.

6. The process claimed in claim 1, wherein the binder to filler weight ratio is from about 0.75:9.25 to about 2:8.

7. The process claimed in claim 1, wherein the filler comprises up to 50% by weight of particles with an average particle diameter smaller than 0.25 microns.

8. The process claimed in claim 1, wherein the filler comprises up to 20% by weight of particles with an average particle diameter smaller than 0.1 microns.

9. The process claimed in claim 1, wherein the one or more fillers comprise particles having particle geometries selected from the group consisting of round, oval, and completely irregular structures.

10. The process claimed in claim 1, wherein the one or more fillers are selected from the group consisting of ground rubber, ground foam, wood flour, comminuted nutshells, metal powder, comminuted plastics waste, comminuted mussel shells, sand, gravel, rock flour, ground marble, ground glass, ground ceramic, and mixtures thereof.

11. The process claimed in claim 1, wherein the shaping apparatus is selected from the group consisting of closed molds, molds with movable rams, platen presses with molds, platen presses without molds, belt presses and twin-belt presses.

12. The process claimed in claim 1, wherein the flexible molding is in the form of a sheet.

13. The process claimed in claim 1, wherein said reacting in step a) is carried out at a pressure of from about 5 MPa to about 30 MPa and a temperature of from about 80° C. to about 120° C.

14. The process claimed in claim 1, wherein the one or more fillers are essentially free of particles having parallel surfaces or flat surfaces.

15. The process claimed in claim 1, wherein the one or more fillers comprise particles having aspect ratios of from about 0.5 to about 2.

16. The process claimed in claim 1, wherein at least one reactant is a polyhydroxy polyether.

17. The process claimed in claim 1, wherein the binder comprises one or more long-chain fatty acids.

18. The process claimed in claim 1, wherein the binder additionally comprises water.

19. The process claimed in claim 1, wherein the binder additionally comprises one or more amines.

20. The process claimed in claim 1, wherein the flexible molding has a microporous foamed structure.

21. The process claimed in claim 1, wherein the binder is comprised of at least one long-chain fatty acid and at least one amine.

22. The process claimed in claim 1, wherein the binder is comprised of at least one di- or trihydric polypropylene glycol having a number average molecular weight of from about 200 to about 6000.

23. The process claimed in claim 1, wherein the binder is comprised of at least one monomeric polyol containing at least two hydroxyl groups per molecule.
